(19) United States
(12) Patent Application Publication
(10) Pub. No.: US 2006/0013407 A1
(43) Pub. Date: Jan. 19, 2006

(54) Methods and apparatus for sound compensation in an acoustic environment

(76) Inventors: Hartley D. Peavey, Meridian, MS (US); Thomas R. Stuckman, Meridian, MS (US); Stephen J. Marks, Meridian, MS (US); James Andrew Bell, Meridian, MS (US)

Correspondence Address: KAPLAN GILMAN GIBSON & DERNIER L.L.P., 900 ROUTE 9 NORTH, WOODBRIDGE, NJ, 07095, US

(21) Appl. No.: 10/894,281

(22) Filed: Jul. 19, 2004

(51) Int. Cl. H04R 29/00; H04R 3/00

(52) U.S. Cl. 381/56; 381/59; 381/96

(57) ABSTRACT

Methods and apparatus are contemplated for providing a primary audio signal containing audio content to one or more primary loudspeakers; and delaying a secondary audio signal containing the same audio content to one or more secondary loudspeakers, wherein the delay is such that respective sound waves originating from the primary and secondary loudspeakers arrive at a location nearer to the secondary loudspeakers without causing sound smear.

### BACKGROUND OF THE INVENTION

The present invention relates to compensating for acoustic problems that arise when sound equipment is used to assist in the amplification of audible content in an acoustic environment.

A typical sound system includes four basic elements, namely one or more microphones, a microphone preamplifier or mixer, a power amplifier and a loudspeaker system. When the sound system is introduced into an acoustic environment, acoustic anomalies are a concern. As the expectations of event-goers have evolved tremendously regarding sound reinforcement, the demands placed on designers/manufacturers of consumer electronics has steadily increased. Everybody expects extremely high quality audio in their cars, home audio and home theatre. Moviegoers expect not only a pleasing visual experience, but also expect a fantastic audio experience. Naturally, this ever increasing level of expectation spills over into virtually every spectator experience, e.g., cinema, automobiles, home entertainment and theatre, and even to attending worship services.

Among the anomalies that may when using a sound system in an acoustic environment is “sound smear.” Sound smear occurs when the same audio content arrives at the ears of a listener at slightly different times, but is not separated enough so as to create a distinct echo. Instead, the same sound content arrives from two or more different sources just close enough together (several thousandths of a second) to combine (smear) and make it very difficult for the listener's brain to decode the audio information into understandable speech.

Sound smear often has a significant impact on consonants, such as the sibilants “S” and “T” etc. Unfortunately, much of the understandability of human speech is contained in these sibilants and the smearing effect results in little or no intelligibility by the listener even if the talker is speaking at a substantial volume.

Although sound smear can occur under many different circumstances, an example is when a pastor of a house of worship speaks to his congregation using the aforementioned electronic sound system. Assume that there is a loudspeaker hanging from the ceiling over the pastor's pulpit, which places the loudspeaker in the same audio source plane as the pastor's face. When he speaks, sound pressure waves project from the pastor's voice box and travel a relatively short distance (at the speed of sound) to a microphone. The microphone converts the pastor's voice into electrical signals (an analog of his voice), which are then amplified and routed to the overhead loudspeaker. Because the pastor's microphone and the overhead loudspeaker are in the same plane (and in substantially vertical alignment) the respective sound pressure waves from the pastor's mouth and the overhead loudspeaker arrive at the ears of the congregation at approximately the same time.

Sound smear may occur when additional reinforcement loudspeakers are positioned at other locations within the house of worship. For example, the space may include a balcony, and one or more small auxiliary loudspeakers may be positioned along the underside of the balcony. This addresses the phenomenon of “shadowing,” where the people sitting under the balcony are effectively in its shadow with respect to hearing the direct sound from the loudspeaker over the pastor's head. The auxiliary loudspeaker(s), however, also set up a sound smear condition. When the pastor speaks, the sound is picked up by the microphone and sent through the electronics to the overhead loudspeaker and simultaneously to the auxiliary loudspeaker(s) under the balcony. The respective sound waves from the pastor's mouth and from the overhead loudspeaker travel to the listener's ears at the speed of sound (about 1130 ft/sec) but the electronic signal driving the auxiliary loudspeaker(s) travels through the wiring at light speed (9.8×10⁸ ft/sec). Thus, the people sitting nearer to the auxiliary loudspeaker(s) (e.g., sitting under the balcony) hear the sound from the auxiliary loudspeakers before they hear the sound direct from the pastor's mouth and/or from the overhead loudspeaker. This results is sound smear and the attendant un-intelligibility.

The difficulty with achieving satisfactory audio results in a place of worship is compounded by numerous factors, such as poor room design, where multiple sound reflecting surfaces exist. Another factor affecting audio results is the experience level of the installers who tend to improperly specify and/or install the audio equipment. Further, and perhaps most importantly, the operation of the sound equipment is most often delegated to a member of the congregation who has little or no background in installing and/or operating the sound equipment. Indeed, numerous instances have occurred in which a member of the congregation is a radio/TV repairman, retired from the phone company, or has other tangentially related experience, and is pressed into service as the operator of the audio equipment. This usually leads to less than satisfactory results (for example, sound smear).

The conventional wisdom in connection with attempts to solve the sound smear problem, particularly in churches, involve the use of generic and/or general purpose sound equipment such as you might find in use by a rock band in a night club, etc. While it is possible to achieve satisfactory results using such general purpose audio equipment, it is significantly difficult and complex to achieve satisfactory results given the specific problems presented by some acoustic spaces, such as churches, which have special requirements. Indeed, these conventional techniques require an array of test equipment, tone sources, meters, oscilloscopes, and sound technicians trained to operated the equipment and perform relatively complex sound measurement and adjustment procedures.

In view of the foregoing, there is a need in the art for new methods and apparatus that provide for manual and/or automatic synchronization of the sound pressure waves emanating from a loudspeaker at the front of a room with the sound pressure waves emanating from other auxiliary loudspeakers so that the direct sound from the front and the direct sound from the sides arrive at a listener's ears within acceptable limits (e.g., at substantially the same time and/or within the parameters established by Helmut Haas, discussed above), thus eliminating intelligibility problems. It is desirable that this synchronization requires little equipment and is easy to operate so that novices may achieve satisfactory results.

### SUMMARY OF THE INVENTION

Aspects of the present invention are directed to simple, operationally intuitive, and automatic methods and apparatus for evaluating and compensating for the sound smear phenomenon in an acoustic environment.

In accordance with various aspects of the invention, it is now possible to delay the audio signals to supplemental loudspeakers throughout the acoustic space, such as the auxiliary loudspeaker(s), by a small amount. This is done to compensate for differences in distance between the sound coming direct from the primary source (e.g., the orator and the substantially co-planar loudspeaker) at the front of the space versus that from the secondary source(s), such as auxiliary loudspeakers under the balcony of a place of worship. The introduction of a slight delay at the auxiliary speakers causes the sound emanating therefrom to reach the ears of certain listeners within acceptable limits (e.g., at approximately the same time and/or within the parameters established by Helmut Haas, discussed above) as compared with the sound from the front of the room (direct from the orator's mouth and the co-planar loudspeaker), thereby eliminating sound smear. The invention contemplates accurately measuring and calibrating the sound characteristics from the primary and secondary sources without requiring specialized instrumentation and training.

In accordance with one or more embodiments of the present invention, an apparatus suitable to carry out the desired features includes: a signal source, such as a pulse generator; a comparator that uses a feed from a main mixer and circuitry that compares that signal to a signal coming from a sensing microphone placed in proximity to a secondary source, e.g., the auxiliary loudspeakers; and a delay system that automatically senses the arrival differential between the primary and secondary sources, generates an error signal used for automatic (or manual) adjustment of an amount of digital delay to effectively correct the sound smear problem. Preferably the apparatus includes a simple visual indication (e.g., one or more LEDs) as to whether the signal has too much or too little delay. For example, a green LED may be energized when the signals from the primary and secondary sources (as sensed by the sense microphone) are synchronized and/or tuned thereby significantly reducing or eliminating the characteristics associated with sound smear and yielding maximum intelligibility of the orator.

The apparatus and methods may be implemented by a freestanding piece of equipment and/or may be integrated into another piece of equipment, such as a sound mixer, power amp, powered loudspeakers, etc. For example, a four-channel power amplifier may be equipped with two of the four channels having the above-described features available as separate delays for each of the channels. This embodiment may use a dual digital delay, and a controller/comparator with three LED's indicating long, short and synchronized (within acceptable delay limits).

In accordance with one or more further aspects of the present invention, methods and apparatus provide for measuring a first delay between a time at which a primary audio signal originates a first sound wave from one or more primary loudspeakers in an acoustic space, and a time at which the first sound wave arrives at a location in the acoustic space; measuring a second delay between a time at which a secondary audio signal originates a second sound wave from one or more secondary loudspeakers in the acoustic space, and a time at which the second sound wave arrives at the location; computing a third delay that is a function of a difference of the first and second delays; providing a primary audio signal containing audio content to the one or more primary loudspeakers; and delaying a secondary audio signal containing the same audio content to the one or more secondary loudspeakers by an amount substantially equal to the third delay, wherein the location is nearer to the secondary loudspeakers than to the primary loudspeakers and the third delay is such that respective sound waves originating from the primary and secondary loudspeakers arrive at the location without causing sound smear.

Further, the methods and apparatus of the present invention may employ a psycho-acoustic phenomena to arrive at the optimal tuning range. The comparator/controller and digital delay circuit may take into account what is generally known as “the Haas precedence effect.” More particularly, the computation of the delay for the programmable delay includes adding an additional delay such that the sound wave originating from the one or more secondary loudspeakers arrives at the location later than the sound wave originating from the one or more primary loudspeakers. The additional delay adheres to the Haas precedence effect such that a listener at the location will likely perceive that both the sound waves originating from the primary and secondary loudspeakers are originating from the one or more main or primary loudspeakers. For example, the additional delay may be at least one of: (i) between about 1 ms to 45 ms; (ii) between about 5 ms to 30 ms; and (iii) between about 10 ms to 20 ms.

The Haas precedence effect is briefly discussed below. In the 1940s, Helmut Haas researched the disrupting affect delayed sound can have on the listener and how delay affects our localization of sound. Using principles based on his research and with the use of modern digital delay lines, the echo and localization problems described above can be overcome and the integration of auxiliary speakers made virtually seamless.

Haas' experiments involved listening tests where one talker's voice was reproduced by two speaker systems, one using a magnetic audio-tape delay. He observed that if the sound arrives from the delayed speaker between 1 and 30 ms after the original that the delayed speaker is not heard at all, even if the volume from each speaker is the same. The sound appears to come only from the non-delayed speaker. However, the perceived volume will be louder resulting from the combined power of the speakers. He further observed that if one speaker is delayed 5 to 30 ms, the delayed speaker needed to be 10 dB greater in volume than the reference speaker for the listener to perceive the volume from the two speakers as equal. As the delay time was further increased, the volume difference must be decreased for the two speakers to appear to be at the same level. Although the sound quality changed somewhat with the delay, it was not considered disturbing, and actually made listening less tiring and more natural. As the delay reached approximately 50 ms, it is possible to discriminate the delayed speaker as a separate echo.

Haas further observed, depending on the rate of speech, that if the amplitude of the echo was equal in volume to 10 dB greater in amplitude than the original sound delays of 40 to 50 ms would disturb only a small percentage of listeners. If the echo signal was reduced in amplitude to 10 dB below the original, no amount of delay disturbed the listeners.

Based on his research, the present invention contemplates that the auxiliary loudspeakers may benefit from sufficient delay of their signal so that its sound arrives at the listener 5 to 30 ms after the arrival of the original sound. Even as the amplitude of this local speaker is increased, the additional delay will help move the sound image toward the original source. As long as the difference in arrival time within the coverage area of the two speaker systems is about 45 ms or less, an echo will not be perceived and listeners should not be disturbed.

Other aspects, features, and advantages of the present invention will be apparent to one skilled in the art from the description herein taken in conjunction with the accompanying drawings.

### DESCRIPTION OF THE DRAWINGS

For the purposes of illustration, there are shown in the drawings forms that are presently preferred, it being understood, however, that the invention is not limited to the precise arrangements and instrumentalities shown.

FIG. 1 is a block diagram of a system for compensating for sound wave propagation delays an acoustic space in accordance with one or more aspects of the present invention;

FIG. 2 is a more detailed block diagram of the system of FIG. 1 in accordance with one or more further aspects of the present invention;

FIG. 3 is a flow diagram illustrating process actions and functions that may be carried out by the system of FIGS. 1-2;

FIG. 4 is a flow diagram illustrating further process actions and functions that may be carried out by the system of FIGS. 1-2; and

FIG. 5 is a flow diagram illustrating still further process actions and functions that may be carried out by the system of FIGS. 1-2 in accordance with one or more aspects of the present invention.

### DETAILED DESCRIPTION OF THE PREFERRED EMBODIMENTS

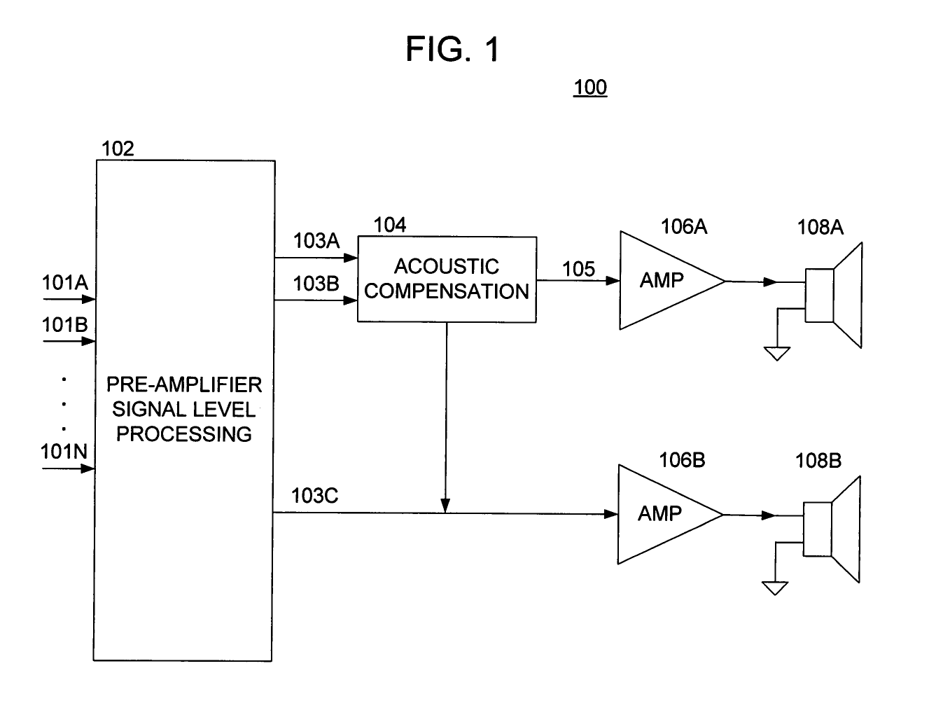

Referring now to the drawings, wherein like numerals indicate like elements, there is shown in FIG. 1 a block diagram of an audio system 100 in accordance with one or more aspects of the present invention. The basic functionality of the audio system 100 is to compensate for acoustic delays of the sound waves emanating from loudspeakers of the system, which delays cause sound smear.

The system 100 includes a pre-amplifier signal level processing unit 102, and acoustic compensation unit 104, a plurality of amplifiers 106, and a corresponding plurality of loudspeakers 108. As has been discussed hereinabove, one of the loudspeakers 108B represents one or more primary acoustic loudspeakers that are used to originate sound waves into an acoustic space for the enjoyment of an audience. The other loudspeaker 108A represents one or more secondary loudspeakers that are disposed some distance away from the primary loudspeaker 108B, for example, to provide additional sound reinforcement in other areas (e.g., beneath a balcony) of the acoustic space for attendees sitting relatively far away from the primary loudspeaker 108B.

The pre-amplifier signal level processing unit 102 may be any of the known audio equipment, such as audio mixing equipment, amplifier equipment, equalization equipment, effects equipment, etc. For the purposes of discussion, the signal level processing unit 102 is assumed to be an audio mixing board receiving a plurality of inputs 101 and producing a plurality of outputs 103. The processing unit 102 is operable to provide a primary audio signal on line 103C containing audio content to the amplifier 106B, which boosts the power level of the signal and drives the primary loudspeaker 108B. The signal level processing unit 102 is also operable to produce a secondary audio signal online 103A containing the same audio content as the primary audio signal, but the secondary signal passes through the acoustic compensation unit 104. The acoustic compensation unit 104 delays the secondary audio signal with respect to the primary audio signal and outputs the delayed signal online 105 to the amplifier 106A. The amplifier 106A increases the power level of the signal and drives the secondary loudspeaker 108A.

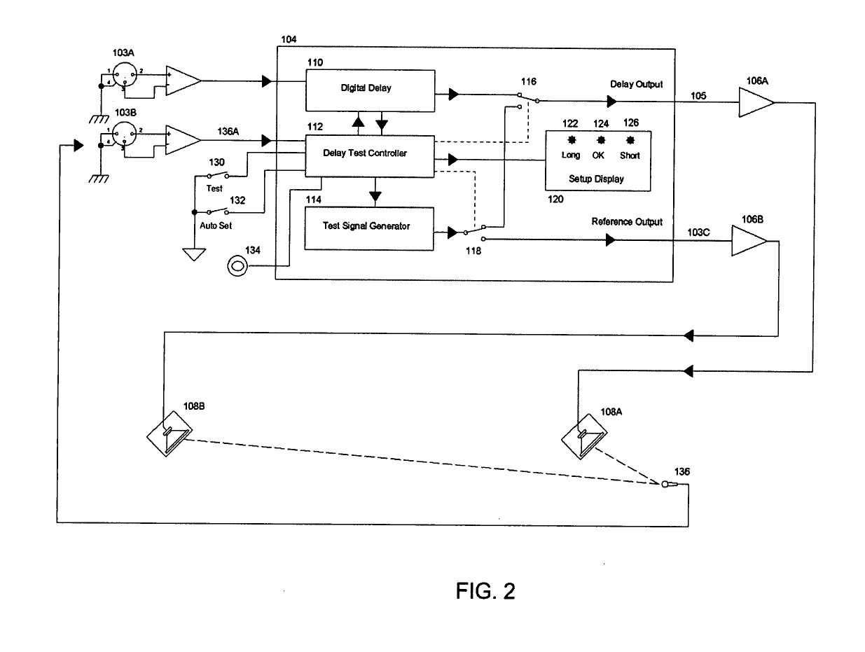

In accordance with various aspects of the present invention, the delay provided by the acoustic compensation unit 104 is such that respective sound waves originating from the primary loudspeaker 108B and the secondary loudspeaker 108A arrive at one or more locations within the acoustic space (such as a location that is nearer to the secondary loudspeaker 108A) without causing sound smear. Further details concerning the operation and capabilities of the acoustic compensation unit 104 will be discussed in more detail with reference to FIG. 2.

FIG. 2 is a more detailed block diagram of the system 100 of FIG. 1, particularly with respect to the functional and structural details of the acoustic compensation unit 104. The connections between the signal level processing unit 102 and the acoustic compensation unit 104 are illustrated by way of a pair of XLR connectors and associated differential amplifiers as would be suitable for use when the acoustic compensation unit 104 is a separate piece of equipment as compared with the signal level processing unit 102. Indeed, it is contemplated that the acoustic compensation unit 104 may be marketed and distributed as a separate piece of equipment useful for augmenting the other equipment of the system 100. It is noted, however, that the acoustic compensation unit 104 need not be separately disposed from, for example, the signal level processing unit 102; rather, it may be integrally disposed within the signal level processing unit 102. Alternatively, the acoustic compensation unit 104 may be integrally disposed within the amplifier 106A or within the amplifier 106B. Still further, some loudspeaker systems are so-called “powered loudspeakers,” where the respective driving amplifiers are integrally disposed in the loudspeaker enclosure. In such equipment, the acoustic compensation unit 104 may be considered to be integrally disposed with the loudspeakers 108.

The acoustic compensation unit 104 may operate in several modes. In a first mode, the acoustic compensation unit 104 is preferably operable to calibrate for the propagation delays associated with sound waves traveling through a given acoustic space to a particular location. For example, a microphone 136 is illustrated as being disposed at a particular location in an acoustic space. The microphone 136 is closer to the secondary loudspeaker 108A than to the primary loudspeaker 108B. As discussed above, the location of the microphone 136 may correspond with the position of an attendee wishing to listen to the audio content emanating from the respective loudspeakers 108. As the primary loudspeaker 108B may represent the approximate location of the orator, without any compensation the sound wave emanating from the secondary loudspeaker 108A would arrive at the microphone 136 sooner than the sound wave emanating from the primary loudspeaker 108B.

In a second mode of operation (e.g., a normal, operational or play mode), the acoustic compensation unit 104 is preferably operable to delay the secondary audio signal on line 105 with respect to the primary audio signal on line 103C by an amount such that the respective sound waves originating from the primary and secondary loudspeakers 108B, 108A arrive at the location of the attendee at substantially the same time, thus avoiding sound smear. As will be discussed in more detail herein below, the amount of delay introduced by the acoustic compensation unit 104 may be adjusted to achieve further psycho-acoustic effects.

The above-mentioned modes of operation and other aspects and features will now be described in connection with further consideration of the functional and structural details of the acoustic compensation unit 104. The acoustic compensation unit 104 preferably includes a digital delay 110, a delay test controller 112, a test signal generator 114, and one or more connection switches 116, 118.

The delay test controller 112 provides numerous functions and capabilities and may be considered to be at the heart of the acoustic compensation unit 104. The delay test controller 112 is preferably operable to establish the mode of operation by way of one or more external inputs, which are preferably user-operated. For example, a first external input may be produced by way of a switch 130 that indicates a user's desire to calibrate any delays associated with the respective positions of the primary loudspeaker 108B, the secondary loudspeaker 108A, and the position of the microphone 136. Another input to the delay test controller 112 may be provided by another switch 132 indicating whether the calibration procedure is to be automatic or manual. Still further, the delay test controller 112 may receive an input from a variable control 134, which indicates a user-desired amount of delay to be introduced as between the primary and secondary audio signals on lines 103C and 105. By way of example, the variable control 134 may be implemented by way of a rotary control that issues an incremental number of pulses indicating an increase or decrease in the desired amount of delay.

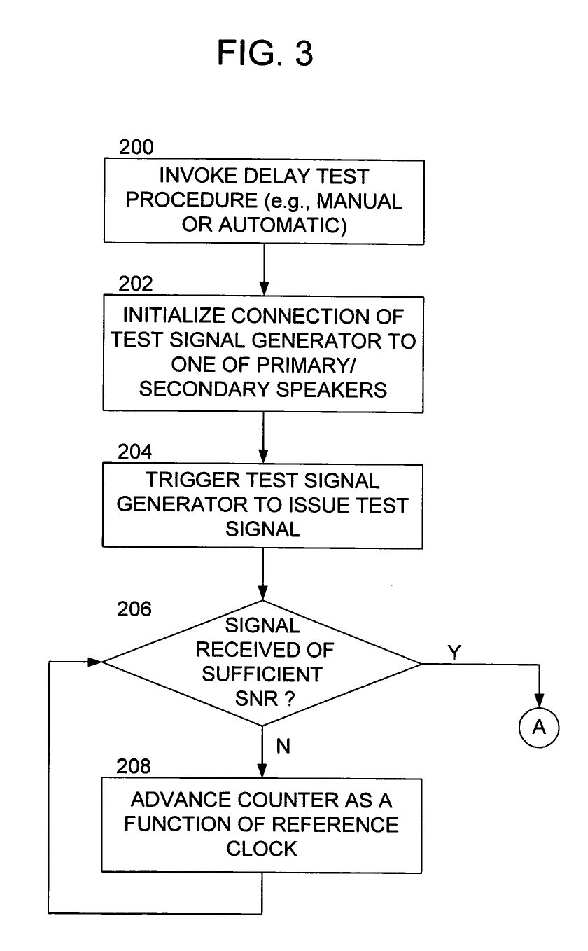

The delay test controller 112 also receives a measured test signal on line 136A from the microphone 136, which will be discussed in further detail hereinbelow. The delay test controller 112 is operatively coupled to the digital delay 110, the test signal generator 114, and the switches 116, 118 to achieve desired functionality as will be discussed below. In this regard, reference is now made to FIGS. 3-5, which are flow diagrams illustrating process actions and functions that may be carried out by the acoustic compensation unit 104 and the other pieces of the system 100 in accordance with one or more aspects of the present invention. At action 200, the system 100 is placed into a calibration mode in which a delay test procedure is invoked. Preferably, this mode of operation is invoked by user-activation of the switch 130, such as causing a ground potential to be input into the delay test controller 112. It is also preferred that an indication be provided as to whether an automatic or manual process is carried out in terms of calibrating the system 100. This indication is preferably achieved by user-activation of the switch 132, which inputs either a ground potential or an open potential (established by a pull-up impedance within the acoustic compensation unit 104). The ground potential may represent the desire for an automatic calibration process and the open potential may represent a desire for a manual calibration process, although those skilled in the art will appreciate that this convention may be easily reversed if desired.

In response to the indication of the calibration mode, the delay test controller 112 preferably initializes connection of the test signal generator 114 to one of the primary and secondary loudspeakers 108B, 108A (for example the primary loudspeaker 108A). The delay test controller 112 is preferably operative to output a signal to the switch 118 that causes the switch 118 to connect the test signal generator 114 to line 103C, thereby establishing a path from the test signal generator 114 to the primary loudspeaker 108B (action 202). At action 204, the delay test controller 112 preferably triggers the test signal generator 114 to issue a test signal to the primary loudspeaker 108B. Although the content of the test signal may have any number of characteristics, it is preferred that the test signal is an impulse, square wave, or other signal that is readily detectable. The test signal is amplified by the amplifier 106B and drives the primary loudspeaker 108B, which produces a sound wave that propagates throughout the acoustic space towards the microphone 136.

From the time that the test signal issues from the test signal generator 114, the delay test controller 112 preferably monitors signaling on line 136A to determine whether a measured signal of sufficient signal-to-noise ratio (SNR) is received (action 206). The signal on line 136A is produced by the microphone 136 and is a measure of the sound wave issuing from the primary loudspeaker 108B. If a result of the determination at action 206 is in the negative, then the process flow advances to action 208, where a counter within the delay test controller 112 advances its count as a function of a reference clock. The process flow then returns to action 206 to determine whether the measured signal on line 136A indicates that the sound wave issuing from the primary loudspeaker 108B has arrived at the microphone 136.

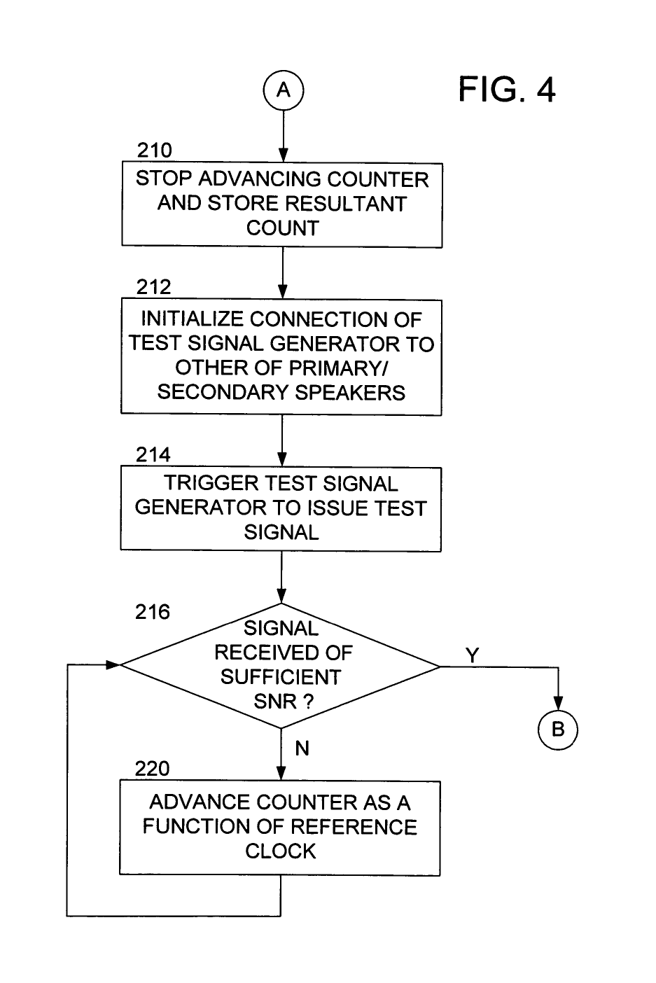

At some point, the sound wave from the primary loudspeaker 108B arrives at the microphone 136, which causes the microphone 136 to produce a measured signal on line 136A of sufficient SNR to trigger an affirmative determination at action 206. At that point, the process flow preferably advances to action 210 (FIG. 4). At action 210, the counter within the delay test controller 112 is stopped and the count value is preferably stored or otherwise maintained for later use. It is noted that the count resulting from actions 204-210 is indicative of the timing delay between the sound wave initiating from the primary loudspeaker 108B and propagating (at approximately 1130 ft/sec) through the acoustic space to the microphone 136.

At action 212 the delay test controller 112 preferably initializes connection of the test signal generator 114 to the other of the primary and secondary loudspeakers 108B, 108A (for example the secondary loudspeaker 108A). The delay test controller 112 is preferably operative to output signals to the switches 116, 118 that establish a path from the test signal generator 114 to the secondary loudspeaker 108A. At action 214, the delay test controller 112 preferably triggers the test signal generator 114 to issue a test signal to the secondary loudspeaker 108A. The test signal is amplified by the amplifier 106A and drives the secondary loudspeaker 108A, which produces a sound wave that propagates throughout the acoustic space towards the microphone 136.

From the time that the test signal issues from the test signal generator 114, the delay test controller 112 preferably monitors signaling on line 136A to determine whether a measured signal of sufficient signal-to-noise ratio (SNR) is received (action 216). The signal on line 136A is produced by the microphone 136 and is a measure of the sound wave issuing from the secondary loudspeaker 108A. If a result of the determination at action 216 is in the negative, then the process flow advances to action 220, where a counter within the delay test controller 112 advances its count as a function of a reference clock. The process flow then returns to action 216 to determine whether the measured signal on line 136A indicates that the sound wave issuing from the secondary loudspeaker 108A has arrived at the microphone 136.

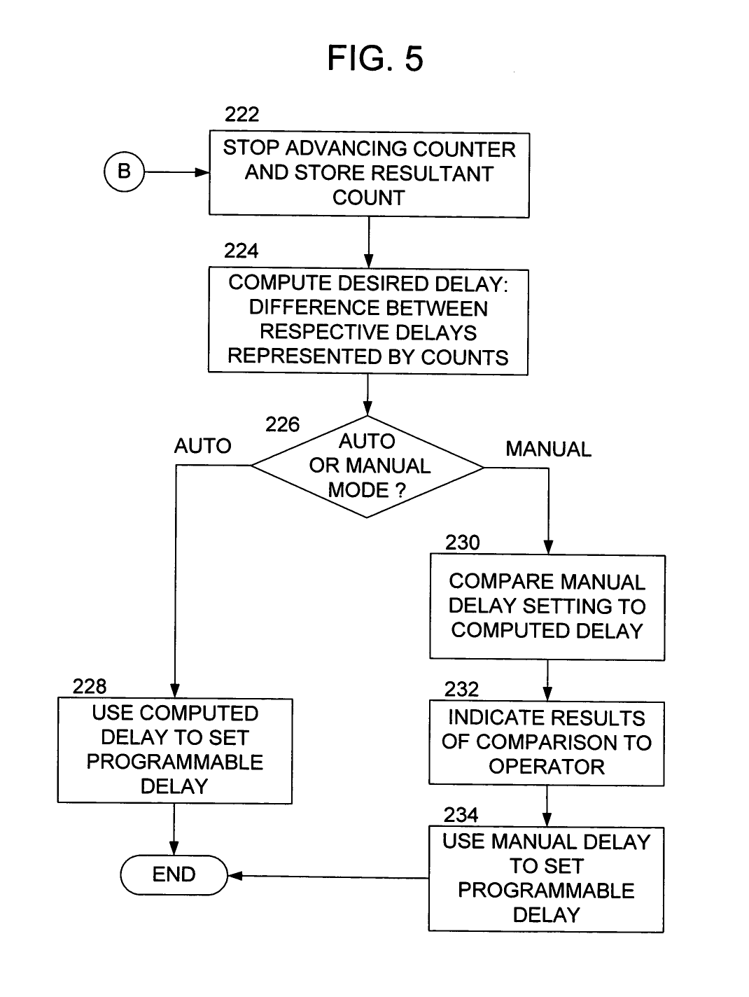

At some point, the sound wave from the secondary loudspeaker 108A arrives at the microphone 136, which causes the microphone 136 to produce a measured signal on line 136A of sufficient SNR to trigger an affirmative determination at action 216. At that point, the process flow preferably advances to action 222 (FIG. 5). At action 222, the counter within the delay test controller 112 is stopped and the count value is preferably stored or otherwise maintained for later use. It is noted that the count resulting from actions 214-222 is indicative of the timing delay between the sound wave initiating from the secondary loudspeaker 108A and propagating (at approximately 1130 ft/sec) through the acoustic space to the microphone 136.

At action 224, the delay test controller 112 preferably computes a desired delay to be used by the digital delay unit 110 to delay the secondary audio signal on line 103A before it is output on line 105. By way of example, the computation of the desired delay may involve taking a difference between the delay associated with the propagation of the sound wave from the primary loudspeaker 108B and the delay associated with the propagation of the sound wave from the secondary loudspeaker 108A to the microphone 136. As the respective counts as measured by the delay test controller 112 represent these delays, the counts may be subtracted and the difference may be utilized to establish the delay time of the digital delay unit 110. When the desired delay is computed in this fashion (and the acoustic compensation unit 104 is operating in the play mode), then the respective sound waves originating from the primary and the secondary loudspeakers 108B, 108A will arrive at the attendee at substantially the same time and sound smear will be substantially reduced and/or eliminated.

In accordance with one or more further aspects of the further invention, there are other ways to compute the desired delay in order to achieve desirable results. For example, the computation of the desired delay may entail subtracting the count value associated with the delay of the secondary loudspeaker 108A from the count value associated with the delay from the primary loudspeaker 108A and adding an additional delay such that (during the play mode of the acoustic compensation unit 104) the sound wave originating from the secondary loudspeaker 108A arrives at the attendee later than the sound wave originating from the primary loudspeaker 108B. Preferably, the additional delay adheres to the Haas precedence effect such that a desirable psycho-acoustic effect is achieved. In particular, this psycho-acoustic effect preferably causes the attendee to perceive that both the sound waves originating from the primary and secondary loudspeakers 108B, 108A are originating from the primary loudspeaker 108B. Indeed, the Haas precedence effect dictates that an additional delay (within limits) will result in the above-described psycho-acoustic effect even when the intensity of the sound wave arriving from the secondary loudspeaker 108A is greater than the intensity of the sound wave arriving from the primary loudspeaker 108B. Preferably, the additional delay is between about 1 ms to 45 ms, between about 5 ms to 30 ms, or between about 10 ms to 20 ms.

In accordance with one or more further aspects of the present invention, the acoustic compensation unit 104 preferably further includes a calibration indication unit 120 that is operable to provide an audible and/or visual indication that the delay of the digital delay unit 110 has taken place. In particular, the calibration indication unit preferably includes one or more lights, such as LEDs 122, 124, 126. The LED 122 is preferably associated with a condition in which the programmed delay is too long as compared to the computed desired delay. The LED 124 is preferably associated with the condition in which the programmed delay is within limits of the computed desired delay (e.g., substantially equal to the desired delay or within acceptable limits). Finally, the LED 126 is preferably associated with the condition in which the programmed delay is too short as compared to the computed desired delay.

The illumination of the LEDs 122, 124, 126 is preferably controlled by the delay test controller 112 during the calibration mode. In particular, at action 226, the delay test controller 112 performs different functions in response to automatic calibration verses manual calibration. In the automatic calibration mode, the process flow preferably advances to action 228, where the computed desired delay is utilized to directly program the digital delay unit 110. In this regard, the delay test controller 112 may illuminate the LED 124 to indicate that the programmed delay corresponds with the computed desired delay.

In the manual calibration mode, however, the delay test controller 112 utilizes a user-defined delay as indicated by the variable control 134. At action 230, the delay test controller 112 preferably compares the user-defined delay (manual delay setting) with the computed desired delay. Any differences between these delays may be indicated to the user/operator by illuminating one of the LEDs 122, 124, 126. For example, when the user-defined delay is smaller than the computed desired delay the delay test controller 112 preferably illuminates the LED 126, thereby indicating that the programmed delay is too short as compared with the desired delay. When the user-defined delay is larger than the computed desired delay, then the delay test controller 112 preferably illuminates the LED 122, thereby indicating that the programmed delay is too long as compared with the computed desired delay. On the other hand, when the user-defined delay is substantially equal to the computed desired delay, then the delay test controller 112 preferably illuminates the LED 124, thereby indicating that the programmed delay is satisfactory.

It is noted that the delay test controller 112 preferably provides some range within which to determine whether the user-defined delay is within limits as compared with the computed desired delay. For example, the delay test controller preferably determines that the user-defined delay is substantially equal to the computed desired delay when the difference therebetween is within about +/−5 ms. At action 234, the user/defined delay is utilized to program the digital delay unit 110.

As described hereinabove, after the calibration mode is completed, the delay test controller 112 preferably removes the test signal generator 114 from providing signaling to the amplifiers 106A, 106B and creates a path from line 103A through the digital delay unit 110 to the amplifier 106A by proper actuation of the switch 116. Thus, primary and secondary audio signaling from the signal level processing unit 102 will arrive at the respective amplifiers 106A, 106B at different times corresponding to the programmed delay within the digital delay unit 110. This results in the aforementioned reduction in sound smear and other unwanted psycho-acoustic effects.

It is noted that the acoustic compensation circuit 104 may be implemented utilizing analog circuitry, or digital circuitry as will be apparent to those skilled in the art. Indeed, the methods and apparatus for acoustic compensation described herein may be achieved utilizing any of the known technologies, such as standard digital circuitry, analog circuitry, any of the known processors that are operable to execute software and/or firmware programs, programmable digital devices or systems, programmable array logic devices, or any combination of the above. It is most preferred that the acoustic compensation circuit 104 is implemented using a DSP chip and associated memory containing a software program that carries out the functionality discussed in detail hereinabove.

In accordance with further aspects of the present invention, the acoustic compensation unit 104 may be implemented as a freestanding piece of equipment and/or may be integrated into another piece of equipment, such as a sound mixer, power amp, powered loudspeakers, etc. Further, more than one acoustic compensation unit 104 may be used in a given application. For example, a four-channel power amplifier may be equipped with two of the four channels having a respective acoustic compensation unit to provide separate delays for each of the channels. This embodiment may use a multiple digital delays, and a controller comparator with three LED's indicating long, short and synchronized (e.g., delay substantially zero and/or within acceptable limits).

It is noted that the boundaries of the functional blocks depicted in FIGS. 1 and 2 have been selected for the purposes of discussion herein, but should not be considered in a way that would limit the invention. Indeed, any combinations of the functional boundaries are considered within the scope of the instant invention as claimed.

Advantageously, the methods and apparatus of the present invention provide for manual and/or automatic synchronization of the sound pressure waves emanating from primary loudspeaker(s) (e.g., at the front of a room) with the sound pressure waves propagating from secondary loudspeaker(s) (e.g., along sides or back of the room) so that the direct sound from the front and the direct sound from the sides arrive at a listener's ears at substantially the same time (or within acceptable limits, such as established by the Haas precedence effect), thus eliminating intelligibility problems.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
measuring a first delay between a time at which a primary audio signal originates a first sound wave from one or more primary loudspeakers in an acoustic space, and a time at which the first sound wave arrives at a location in the acoustic space;
measuring a second delay between a time at which a secondary audio signal originates a second sound wave from one or more secondary loudspeakers in the acoustic space, and a time at which the second sound wave arrives at the location;
computing a third delay that is a function of a difference of the first and second delays;
providing a primary audio signal containing audio content to the one or more primary loudspeakers; and
delaying a secondary audio signal containing the same audio content to the one or more secondary loudspeakers by an amount substantially equal to the third delay,
wherein the location is nearer to the secondary loudspeakers than to the primary loudspeakers and the third delay is such that respective sound waves originating from the primary and secondary loudspeakers arrive at the location without causing sound smear.

2. The method of claim 1, wherein the step of measuring the first delay includes:
monitoring sound waves at the location using an acoustic pickup; and
counting a first number of cycles of a clock signal occurring between a time at which a test sound wave originates from the primary loudspeakers, and a time at which the acoustic pickup monitors that the test sound wave arrives.

3. The method of claim 2, wherein the step of measuring the second delay includes counting a second number of cycles of the clock signal occurring between a time at which a test sound wave originates from the secondary loudspeakers, and a time at which the acoustic pickup monitors that the test sound wave arrives.

4. The method of claim 1, wherein the step of computing the third delay includes subtracting the second number of clock cycles from the first number of clock cycles such that the respective sound waves originating from the primary and secondary loudspeakers arrive at the location at substantially the same time.

5. The method of claim 1, wherein the step of computing the third delay includes subtracting the second number of clock cycles from the first number of clock cycles and adding an additional delay such that the sound wave originating from the one or more secondary loudspeakers arrives at the location later than the sound wave originating from the one or more primary loudspeakers.

6. The method of claim 5, wherein:
the additional delay adheres to the Haas precedence effect such that a psycho-acoustic effect is achieved whereby a listener at the location will likely perceive that both the sound waves originating from the primary and secondary loudspeakers are originating from the one or more primary loudspeakers.

7. The method of claim 6, wherein the additional delay is at least one of: (i) between about 1 ms to 45 ms; (ii) between about 5 ms to 30 ms; and (iii) between about 10 ms to 20 ms.

8. The method of claim 1, further comprising using the third delay to program variable digital delay device to delay the secondary audio signal to the one or more secondary loudspeakers.

9. The method of claim 8, wherein the variable digital delay is programmed either automatically or manually.

10. The method of claim 8, further comprising providing at least one of an audible and visual indication that the third delay has been successfully programmed.

11. The method of claim 10, wherein the visual indication includes at least one LED that illuminates when the third delay is properly set such that respective sound waves originating from the primary and secondary loudspeakers arrive at the location without causing sound smear.

12. The method of claim 11, further comprising providing a visual indication on further LEDs when the programmed delay is either too long or too short.

13. A method, comprising:
providing a primary audio signal containing audio content to one or more primary loudspeakers; and
delaying a secondary audio signal containing the same audio content to one or more secondary loudspeakers,
wherein the delay is such that respective sound waves originating from the primary and secondary loudspeakers arrive at a location nearer to the secondary loudspeakers without causing sound smear.

14. The method of claim 13, further comprising:
measuring a first delay between a time at which a test signal originates a first sound wave from the one or more primary loudspeakers, and a time at which the first sound wave arrives at the location;
measuring a second delay between a time at which a test signal originates a second sound wave from the one or more secondary loudspeakers, and a time at which the second sound wave arrives at the location;
computing a third delay that is a function of a difference of the first and second delays;
receiving a user-defined delay to establish the delay of the secondary audio signal; and
comparing the user-defined delay with the third delay to and providing at least one of an audible and visual indication as to whether at least one of: (i) the user-defined delay is smaller than the third delay, (ii) the user-defined delay is larger than the third delay, and (iii) the user-defined delay is substantially equal to the third delay.

15. The method of claim 14, further comprising determining that the user-defined delay is substantially equal to the third delay when a difference therebetween is within about +/−5 ms.

16. The method of claim 14, wherein the step of computing the third delay includes subtracting the second delay from the first delay and adding an additional delay such that the sound wave originating from the one or more secondary loudspeakers arrives at the location later than the sound wave originating from the one or more primary loudspeakers.

17. The method of claim 16, wherein the additional delay is a function of the Haas precedence effect such that a psycho-acoustic effect is achieved whereby a listener at the location will likely perceive that both the sound waves originating from the primary and secondary loudspeakers are originating from the one or more primary loudspeakers.

18. The method of claim 17, wherein the additional delay is at least one of: (i) between about 1 ms to 45 ms; (ii) between about 5 ms to 30 ms; and (iii) between about 10 ms to 20 ms.

19. The method of claim 13, further comprising:
measuring a first delay between a time at which a test signal originates a first sound wave from the one or more primary loudspeakers, and a time at which the first sound wave arrives at the location;
measuring a second delay between a time at which a test signal originates a second sound wave from the one or more secondary loudspeakers, and a time at which the second sound wave arrives at the location;
computing a third delay that is a function of a difference of the first and second delays; and
automatically adjusting the delay of the secondary audio signal to coincide with the third delay.

20. The method of claim 13, further comprising positioning the one or more primary loudspeakers substantially co-planar with an orator, who's voice is used to produce the primary audio signal and the secondary audio signal, wherein the location near the one or more secondary loudspeakers is relatively far from at least one of the primary loudspeakers and the orator.

21. An apparatus, comprising:
a signal generator operable to produce an audio test signal for driving one or more primary loudspeakers and one or more secondary loudspeakers in an acoustic environment;
at least one acoustic pickup device operable to be disposed at a location farther from the one or more primary loudspeakers than from the one or more secondary loudspeakers;
at least one input port operable to receive a measured test signal from the at least one acoustic pickup device;
a delay monitoring unit operable to: (i) measure a first delay between a time at which the test signal causes a first sound wave to originate from the one or more primary loudspeakers, and a time at which the measured test signal indicates that the first sound wave arrives at the acoustic pickup device, and (ii) measure a second delay between a time at which the test signal causes a second sound wave to originate from the one or more secondary loudspeakers, and a time at which the measured test signal indicates that the second sound wave arrives at the acoustic pickup device;
a delay computation unit operable to compute a third delay that is a function of a difference of the first and second delays; and
a programmable delay unit operable to delay a secondary audio signal containing audio content to the one or more secondary loudspeakers by an amount at least one of automatically and manually specified,
wherein when the delay of the secondary audio signal is substantially equal to the third delay, a resulting sound wave originating from the one or more secondary loudspeakers arrives at the location in the acoustic space, relative to arrival of a sound wave caused by a primary audio signal containing the same audio content originating from the one or more primary loudspeakers, such that sound smear is reduced.

22. The apparatus of claim 21, wherein the delay monitoring unit includes at least one counter that is operable to:
count a first number of cycles of a clock signal occurring between the time at which the test signal causes the first sound wave to originate from the one or more primary loudspeakers, and the time at which the measured test signal indicates that the first sound wave arrives at the acoustic pickup device; and
count a second number of cycles of the clock signal occurring between the time at which the test signal causes the second sound wave to originate from the one or more secondary loudspeakers, and the time at which the measured test signal indicates that the second sound wave arrives at the acoustic pickup device.

23. The apparatus of claim 22, wherein the delay computation unit is operable to compute the third delay by subtracting the second number of clock cycles from the first number of clock cycles such that the respective sound waves originating from the primary and secondary loudspeakers will arrive at the location at substantially the same time when the secondary audio signal is delayed by the third delay.

24. The apparatus of claim 22, wherein the delay computation unit is operable to compute the third delay by subtracting the second number of clock cycles from the first number of clock cycles and adding an additional delay such that the sound wave originating from the one or more secondary loudspeakers arrives at the location later than the sound wave originating from the one or more primary loudspeakers when the secondary audio signal is delayed by the third delay.

25. The apparatus of claim 24, wherein the additional delay adheres to the Haas precedence effect such that a psycho-acoustic effect is achieved whereby a listener at the location will likely perceive that both the sound waves originating from the primary and secondary loudspeakers are originating from the one or more primary loudspeakers when the secondary audio signal is delayed by the third delay.

26. The method of claim 25, wherein the additional delay is at least one of: (i) between about 1 ms to 20 ms; (ii) between about 5 ms to 10 ms; and (iii) between about 10 ms to 20 ms.

27. The apparatus of claim 21, further comprising a controller unit operable to program the programmable delay unit to delay the secondary audio signal either automatically or in response to a manual input from an operator.

28. The apparatus of claim 27, wherein the controller unit is operable to receive the manual input and to program the programmable delay unit to delay the secondary audio signal by a corresponding amount.

29. The apparatus of claim 28, further comprising a calibration indication unit operable to provide at least one of an audible and visual indication that the delay of the secondary signal has been programmed.

30. The apparatus of claim 29, wherein the controller unit is operable to compare the manual input delay with the third delay and to signal the calibration indication unit to provide an indication as to whether at least one of: (i) the manual input delay is smaller than the third delay, (ii) the manual input delay is larger than the third delay, and (iii) the manual input delay is substantially equal to the third delay.

31. The method of claim 30, further comprising determining that the manual input delay is substantially equal to the third delay when a difference therebetween is within about +/−5 ms.

32. The apparatus of claim 30, wherein the calibration indication unit includes at least one LED that illuminates when the manual input delay is substantially equal to the third delay such that respective sound waves originating from the primary and secondary loudspeakers arrive at the location without causing sound smear.

33. The apparatus of claim 32, wherein the calibration indication unit includes further LEDs that are operable to provide a further visual indication when the manual input delay is either too long or too short with respect to the third delay.

34. The apparatus of claim 21, wherein the apparatus is integrally disposed with at least one of audio mixing equipment, power amplifier equipment, and powered loudspeaker equipment.
